(19) United States
(12) Patent Application Publication
(10) Pub. No.: US 2026/0178696 A1
(43) Pub. Date: Jun. 25, 2026

(54) HARDWARE ACCELERATOR FOR MATRIX MULTIPLICATION OPERATIONS

(71) Applicant: Glenfly Tech Co., Ltd., Shanghai (CN)

(72) Inventor: Yiding XU, Shanghai (CN)

(21) Appl. No.: 19/255,662

(22) Filed: Jun. 30, 2025

(30) Foreign Application Priority Data
Dec. 19, 2024 (CN) 202411885955.X

(51) Int. Cl. G06F 17/16

(52) U.S. Cl. CPC G06F 17/16

(57) ABSTRACT

A hardware accelerator is provided, including a data acquisition module and a matrix multiplication computation module. The data acquisition module acquires a first matrix forming a first data queue in a first dimension and a second dimension, and a second matrix forming a second data queue in the first dimension and a third dimension. The matrix multiplication computation module includes a three-dimensional array including a plurality of processing elements. Positions of the processing elements are determined based on first dimension values, second dimension values and third dimension values of the processing elements. The processing elements obtain corresponding first data from the first data queue based on the first dimension values and the second dimension values, obtain corresponding second data from the second data queue based on the first dimension values and the third dimension values, and perform matrix multiplication calculation based on the first data and the second data.

### CROSS-REFERENCE TO RELATED APPLICATIONS

The present application claims priority to Chinese patent application No. 202411885955X, filed on Dec. 19, 2024, the entire content of which is incorporated herein by reference.

### TECHNICAL FIELD

The present disclosure relates to the field of matrix multiplication operations, and in particular, to a hardware accelerator for matrix multiplication operations.

### BACKGROUND

With the emergence and development of emerging fields such as artificial intelligence, big data, and image processing, large and complex algorithms require a large number of vector operations. Especially, matrix multiplication is widely present in a large number of algorithms. Due to the high computational complexity and low processing efficiency of large-scale matrix multiplication, in scenarios with high requirements for algorithm real-time performance, matrix multiplication often becomes a bottleneck that limits system performance.

As algorithms increasingly demand hardware computational power, using dedicated hardware to accelerate matrix multiplication operations has become a development trend. Due to the special nature of accelerators, GPUs have relatively fast execution speed, low power consumption, and low cost compared to the accelerators.

### SUMMARY

A hardware accelerator for matrix multiplication operations is provided to solve the problems in the above-mentioned background, which can at least improve the hardware computational power for matrix multiplication operations.

To achieve the above objectives and other related objectives, a hardware accelerator for matrix multiplication operations is provided in an aspect of the present disclosure. The hardware accelerator includes a data acquisition module and a matrix multiplication computation module.

The data acquisition module is configured to acquire a first matrix and a second matrix. The first matrix forms a first data queue in a first dimension and a second dimension. The second matrix forms a second data queue in the first dimension and a third dimension.

The matrix multiplication computation module includes a three-dimensional array. The three-dimensional array includes a plurality of processing elements. Positions of the processing elements in the three-dimensional array is determined based on first dimension values, second dimension values and third dimension values of the processing elements, respectively. The processing elements are configured to obtain corresponding first data from the first data queue based on the first dimension values and the second dimension values, obtain corresponding second data from the second data queue based on the first dimension values and the third dimension values, and perform matrix multiplication computation based on the first data and the second data.

In an embodiment, each of the plurality of the processing elements includes a multiply-accumulate unit. The multiply-accumulate unit includes a multiplier and an adder. The multiplier is configured to obtain products of the first data in the first matrix and the second data in the second matrix. The adder is configured to accumulate the products along the first dimension.

In an embodiment, the matrix multiplication computation module further includes a plurality of adding units. Each of the plurality of adding units includes an adder. The adding units are arranged in a one-to-one correspondence with the processing elements at an end of the first dimension of the three-dimensional array. The adding units are configured to obtain an accumulated value of the products from the processing elements at the end of the first dimension of the three-dimensional array.

In an embodiment, on a condition that the processing element has a first dimension value of A, a second dimension value of B, and a third dimension value of C in the three-dimensional array, the first data which with the first dimension value of A and the second dimension value of B in a data queue of the first matrix are acquired, and the second data which with the first dimension value of A and the third dimension value of C in a data queue of the second matrix are acquired by the processing element, and matrix multiplication computations are performed using the first data and the second data.

In an embodiment, on a condition that the multiply-accumulate unit has a first dimension value of A, a second dimension value of B, and a third dimension value of C in the three-dimensional array. Products using the first data and the second data are acquired, the first data having the first dimension value of A and the second dimension value of B in the first matrix, the second data having the first dimension value of A and the third dimension value of C in the second matrix. An accumulated value of the products from all the multiply-accumulate units with the first dimension value less than or equal to A, the second dimension value of B, and the third dimension value of C in the three-dimensional array is acquired.

In an embodiment, on a condition that the first dimension value of a first multiply-accumulate unit is less than the first dimension value of a second multiply-accumulate unit from the multiply-accumulate units, a first time at which the first multiply-accumulate unit acquires data is earlier than a second time at which the second multiply-accumulate unit acquires data.

In an embodiment, the first data queue and the second data queue are arranged in staggered rows.

In an embodiment, on a condition that a quantity of data of the first matrix and/or the second matrix in any dimension is less than a number of the processing elements or an integer multiple of the number of the processing elements of the three-dimensional array in the dimension, the quantity of data in the first matrix and/or the second matrix in the dimension is padded with zeros to the number of the processing elements or the integer multiple of the number of the processing elements of the three-dimensional array in the dimension.

In an embodiment, a computational scale of the three-dimensional array is proportional to a computational power of the matrix multiplication computation module.

In an embodiment, the first matrix includes a data matrix. The second matrix includes a weight matrix.

According to the hardware accelerator for matrix multiplication operations provided by the present disclosure, the data acquisition module acquires two matrices by performing matrix multiplication operations to form data queues. Each of the processing elements in the matrix multiplication computation module that forms the three-dimensional array acquires corresponding data in the two matrices to perform matrix multiplication operations, thereby improving the hardware computational power of the matrix multiplication operations.

### BRIEF DESCRIPTION OF THE DRAWINGS

In order to better describe and illustrate the embodiments and/or examples of the present disclosure, reference may be made to one or more drawings. The accompanying details or examples used to describe the accompanying drawings should not be considered a limitation on the scope of any of the present disclosure, the embodiments and/or examples presently described, and the best mode of the present disclosure as presently understood.

FIG. 1 is a schematic block diagram of a hardware accelerator for matrix multiplication operations provided in an embodiment.

FIG. 2 is a schematic diagram of a structure of a matrix multiplication computation module provided in an embodiment.

FIG. 3 is a schematic diagram of matrix multiplication computation module configured for adding computation data provided in an embodiment.

FIG. 4 is a front view of a matrix multiplication computation module configured for matrix multiplication computations provided in an embodiment.

FIG. 5 is a top view of a matrix multiplication computation module configured for matrix multiplication computations provided in an embodiment.

FIG. 6 is a schematic diagram of a data sequence of a matrix multiplication computation module configured for matrix multiplication computations provided in an embodiment.

FIG. 7 is a schematic diagram of a computational process of multiplying a first row and a first column of a 19×19 matrix multiplication provided in an embodiment.

FIG. 8 is a schematic diagram of a matrix multiplication computation module for int16 and int8 performing data computations provided in an embodiment.

FIG. 9 is a schematic diagram of a data cache module provided in an embodiment.

FIG. 10 is a schematic diagram of a data sequence of a data queue provided in an embodiment.

FIG. 11 is a schematic diagram of a storage configuration of a data queue provided in an embodiment.

FIG. 12 is a schematic diagram of a matrix multiplication computation module with a 4×4×4 computational scale provided in an embodiment.

FIG. 13 is a schematic diagram of a matrix multiplication computation module with an 8×8×8 computational scale provided in an embodiment.

FIG. 14 is a schematic diagram of a matrix multiplication computation module with a 16×16×16 computational scale provided in an embodiment.

FIG. 15 is a schematic diagram of a submatrix operation sequence of matrix multiplication between M×K and K×N matrices provided in an embodiment.

### DETAILED DESCRIPTION OF THE EMBODIMENTS

In order to facilitate understanding of the present disclosure, the present disclosure will be described more fully below with reference to the accompanying drawings. The preferred embodiments of the present disclosure are given in the accompanying drawings. However, the present disclosure can be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein have the same meaning as those commonly understood by those skilled in the art to which the present disclosure belongs. The terms used herein in the specification of the present disclosure are only for the purpose of describing specific embodiments and are not intended to limit the present disclosure. The term “and/or” used herein includes any and all combinations of one or more of the related listed items.

The purpose of the terms used herein is only to describe specific embodiments and is not intended to be limiting of the present application. When used herein, the singular forms “one”, “an” and “said/the” are also intended to include plural forms, unless the context clearly indicates otherwise. It should also be understood that the terms “comprise” and/or “include”, when used in this specification, determine the presence of the features, integers, steps, operations, elements and/or components, but do not exclude the presence or addition of one or more other features, integers, steps, operations, elements, components and/or groups. When used herein, the term “and/or” includes any and all combinations of the relevant listed items.

It should be noted that the schematic diagrams provided in this embodiment are merely schematic illustrations of the basic concept of the present application. Although the schematic diagrams only show components related to the present application and are not drawn according to the number, shape and size of components in actual implementation, the type, quantity and proportion of each component in actual implementation may be changed arbitrarily, and layout type of each component may also be more complicated.

A hardware accelerator for matrix multiplication operations is provided in the present disclosure, including a data acquisition module and a matrix multiplication computation module.

The data acquisition module is configured to acquire a first matrix and a second matrix. The first matrix forms a first data queue in a first dimension and a second dimension. The second matrix forms a second data queue in the first dimension and a third dimension.

The matrix multiplication computation module includes a three-dimensional array. The three-dimensional array includes a plurality of processing elements. The position of the processing elements in the three-dimensional array are determined based on first dimension values, second dimension values and third dimension values of the processing elements, respectively. The processing elements are configured to obtain corresponding first data from the first data queue based on the first dimension values and the second dimension values, obtain corresponding second data from the second data queue based on the first dimension values and the third dimension values, and perform matrix multiplication computation based on the first data and the second data.

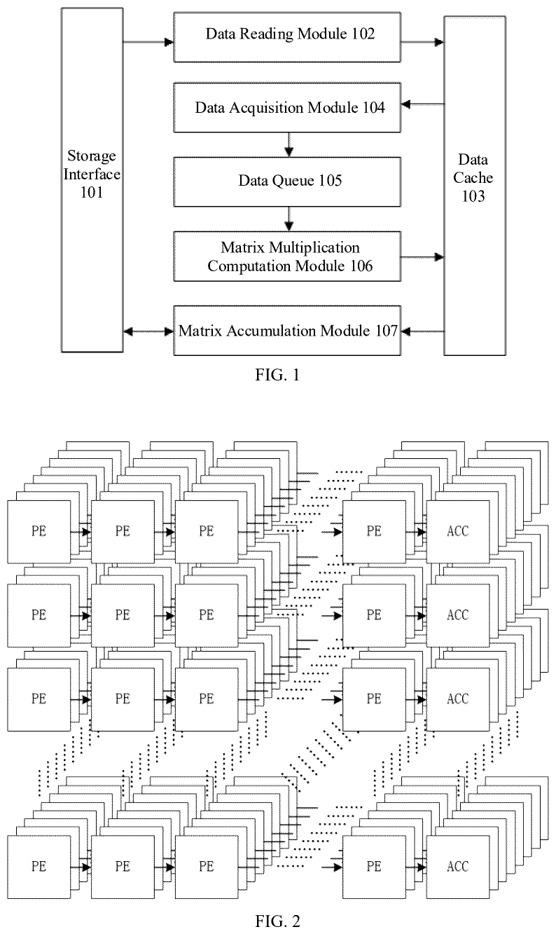

As shown in FIG. 1, a hardware accelerator for matrix multiplication operations includes a storage interface 101, a data reading module 102, a data cache 103, a data acquisition module 104, a data queue 105, a matrix multiplication computation module 106 and a matrix accumulation module 107.

In an embodiment, the data reading module 102 initiates a data acquisition request, obtains data from an external storage through the storage interface 101, and stores the obtained data in the data cache 103. The data acquisition module 104 obtains required data from the data cache 103, and puts the obtained data into the data queue 105 according to a computational sequence. The matrix multiplication computation module 106 obtains the data in the data queue 105 for computation, and stores the result in the data cache 103 after the computation is completed. The matrix accumulation module 107 obtains data from the external storage through the storage interface 101, and then obtains a computation result from the data cache 103. The matrix accumulation module 107 adds the data in the external storage and the computation result in the data cache 103 to obtain an accumulated result, and finally writes the accumulated result to the external storage through the storage interface 101.

As shown in FIG. 2, the matrix multiplication computation module 106 includes a three-dimensional array. The three-dimensional array includes a plurality of processing elements (PE). The processing element adopts a multiply-accumulate unit. Each multiply-accumulate unit includes a multiplier and an adder. The multiplier is configured to obtain products of the first data in the first matrix and the second data in the second matrix. The adder is configured to accumulate the products along the first dimension. Furthermore, the matrix multiplication computation module 106 further includes a plurality of adding units (Accumulator, ACC) arranged at an end of the first dimension of the three-dimensional array which includes the plurality of processing elements (PE). The adding unit includes an adder. The adding units are arranged in a one-to-one correspondence with the processing elements at an end of the first dimension of the three-dimensional array. The adding units are configured to obtain an accumulated value of the products from the processing elements at the end of the first dimension of the three-dimensional array.

In an embodiment, the direction of the data queue formed by the two matrices matches the accumulation direction of the multiply-accumulate unit and the adding unit. Specifically, a first data queue of the first dimension and the second dimension is formed based on the first matrix. A second data queue of the first dimension and the third dimension is formed based on the second matrix. The first dimension is a common direction of the first data queue and the second data queue, and therefore the adding units are correspondingly arranged at the end of the first dimension of the three-dimensional array.

It should be noted that the first dimension, the second dimension and the third dimension constitute a Cartesian three-dimensional coordinate system. The first dimension, the second dimension and the third dimension are respectively one of a X direction, a Y direction and a Z direction. For example, the first dimension is the X direction, the second dimension is the Y direction, and the third dimension is the Z direction. In addition, the first dimension may also be the Y direction or the Z direction, which is not limited in the present disclosure.

In an embodiment, on a condition that the first matrix is an 8×8 data matrix and the second matrix is an 8×8 weight matrix, the matrix multiplication computation of the data matrix and the weight matrix is as shown in equation (1):

$$[ \begin{matrix}{O}_{0 \_ 0} & {O}_{0 \_ 1} & {O}_{0 \_ 2} & … & {O}_{0 \_ 7} \\ {O}_{1 \_ 0} & {O}_{1 \_ 1} & {O}_{1 \_ 2} & ⋯ & {O}_{1 \_ 7} \\ {O}_{2 \_ 0} & {O}_{2 \_ 1} & {O}_{2 \_ 2} & … & {O}_{2 \_ 7} \\ ⋮ & ⋮ & ⋮ & ⋱ & ⋮ \\ {O}_{7 \_ 0} & {O}_{7 \_ 1} & {O}_{7 \_ 2} & … & {O}_{7 \_ 7}\end{matrix} ] = [ \begin{matrix}{D}_{0 \_ 0} & {D}_{0 \_ 1} & {D}_{0 \_ 2} & … & {D}_{0 \_ 7} \\ {D}_{1 \_ 0} & {D}_{1 \_ 1} & {D}_{1 \_ 2} & ⋯ & {D}_{1 \_ 7} \\ {D}_{2 \_ 0} & {D}_{2 \_ 1} & {D}_{2 \_ 2} & … & {D}_{2 \_ 7} \\ ⋮ & ⋮ & ⋮ & ⋱ & ⋮ \\ {D}_{7 \_ 0} & {D}_{7 \_ 1} & {D}_{7 \_ 2} & … & {D}_{7 \_ 7}\end{matrix} ] \times [ \begin{matrix}{W}_{0 \_ 0} & {W}_{0 \_ 1} & {W}_{0 \_ 2} & … & {W}_{0 \_ 7} \\ {W}_{1 \_ 0} & {W}_{1 \_ 1} & {W}_{1 \_ 2} & ⋯ & {W}_{1 \_ 7} \\ {W}_{2 \_ 0} & {W}_{2 \_ 1} & {W}_{2 \_ 2} & … & {W}_{2 \_ 7} \\ ⋮ & ⋮ & ⋮ & ⋱ & ⋮ \\ {W}_{7 \_ 0} & {W}_{7 \_ 1} & {W}_{7 \_ 2} & … & {W}_{7 \_ 7}\end{matrix} ] \qquad ( 1 )$$

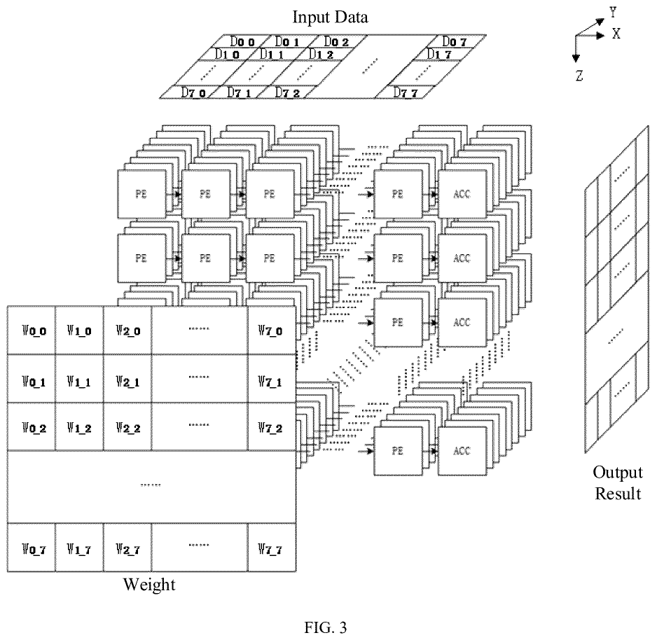

In an embodiment, taking the matrix multiplication computation module 106 of 8×8×8 computational scale as an example, the data acquisition module 104 puts the data of the untransposed data matrix into the first data queue (input data) shown in FIG. 3, and put the data of the transposed weight matrix into the second data queue (weight) shown in FIG. 3. The matrix multiplication computation module 106 acquires the data in the data queue 105 for computation. Specifically, the row data of the data matrix are arranged along the first dimension (X direction), the column data of the data matrix are arranged along the second dimension (Y direction), the column data of the weight matrix are arranged along the first dimension (X direction), and the row data of the weight matrix are arranged along the third dimension (Z direction). Since the row data of the data matrix and the column data of the weight matrix are arranged along the first dimension (X direction), the accumulation directions of the multiply-accumulate units and the adding units perform accumulation along the first dimension (X direction).

Exemplarily, on a condition that the processing element has a first dimension value of A, a second dimension value of B, and a third dimension value of C in the three-dimensional array, the first data with the first dimension value of A and the second dimension value of B in a data queue of the first matrix are acquired, the second data with the first dimension value of A and the third dimension value of C in a data queue of the second matrix are acquired by the processing element, and matrix multiplication computations are performed on the first data and the second data. Furthermore, on a condition that the multiply-accumulate unit has a first dimension value of A, a second dimension value of B, and a third dimension value of C in the three-dimensional array, products of the first data and the second data are acquired, where the first data have the first dimension value of A and the second dimension value of B in the first matrix, and the second data have the first dimension value of A and the third dimension value of C in the second matrix. An accumulated value of the products from all the multiply-accumulate units with the first dimension value less than or equal to A, the second dimension value of B, and the third dimension value of C in the three-dimensional array is also acquired.

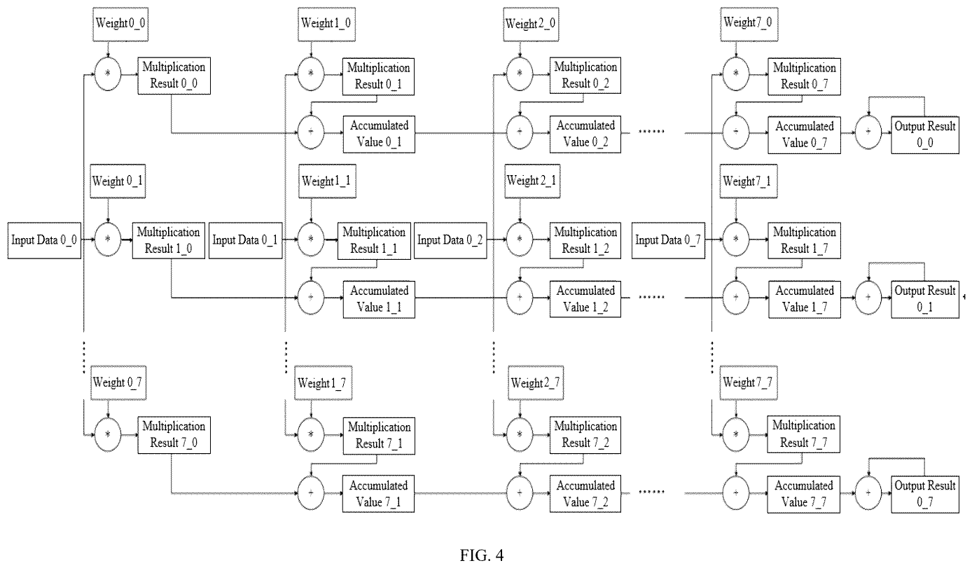

In an embodiment, FIG. 4 is a front view of the matrix multiplication computation module 106, i.e., a schematic diagram of the matrix multiplication computations of the processing elements of the first dimension (X direction) and the third dimension (Z direction) when the second dimension (Y direction) is 1. As shown in FIG. 4, since the second dimension (Y direction) from the front view is 1, the input data are data (D0_0, D0_1, D0_2, . . . . D0_7) in the data queue of the data matrix that have the first dimension value ranging from 1 to 7 and the second dimension of 1.

The data queue of the weight matrix includes data of the first dimension (X direction) and the third dimension (Z direction), which are arranged in a one-to-one correspondence with the processing elements of the first dimension (X direction) and the third dimension (Z direction).

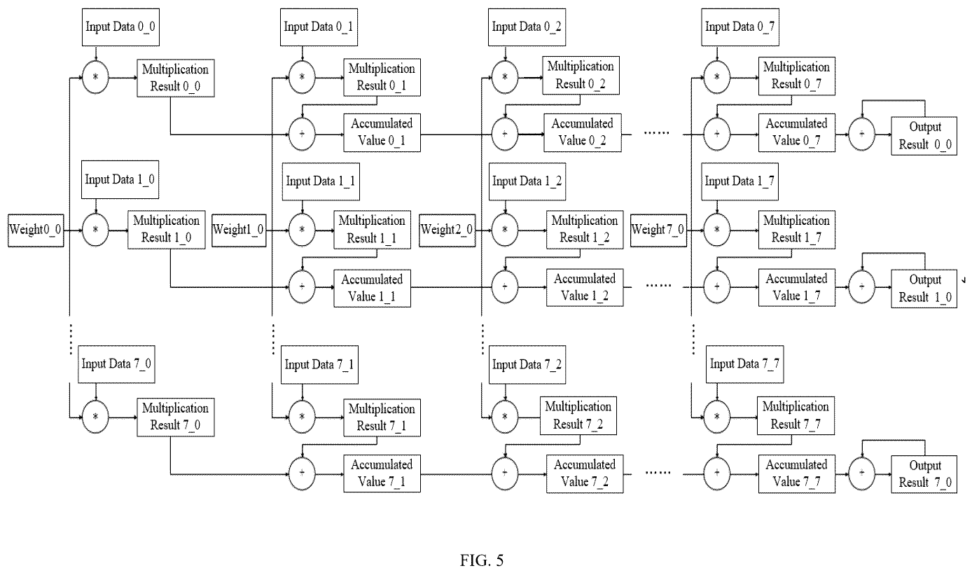

In an embodiment, FIG. 5 shows a top view of the matrix multiplication computation module 106, i.e., a schematic diagram of the matrix multiplication computations of the processing elements of the first dimension (X direction) and the second dimension (Y direction) when the third dimension (Z direction) is 1. As shown in FIG. 5, since the third dimension (Z direction) from the top view is 1, the input data are data (W0_0, W1_0, W2_0, . . . . W7_0) in the data queue of the weight matrix that have the first dimension value ranging from 1 to 7 and the third dimension value of 1. The data queue of the data matrix includes data of the first dimension (X direction) and the second dimension (Y direction), which are arranged in a one-to-one correspondence with the processing elements of the first dimension (X direction) and the second dimension (Y direction).

In an embodiment, for a processing element located in a three-dimensional array, where the first dimension value is 3, the second dimension value is 1, and the third dimension value is 2, the processing element acquires data D0_2 with a first dimension value of 3 and a second dimension value of 1 in the data queue of the data matrix, and acquires data W2_1 with the first dimension value of 3 and the third dimension value of 2 in the data queue of the weight matrix. The matrix multiplication computation performed by the processing element includes the multiplier acquiring the product of D0_2×W2_1, and the adder acquiring the accumulated value D0_0×W0_1+D0_1×W1_1+D0_2×W2_1 of the products from all the multiply-accumulate units with first dimension values of 1, 2, and 3, the second dimension value of 1, and the third dimension value of 2.

Exemplarily, on a condition that the first dimension value of a first multiply-accumulate unit is less than the first dimension value of a second multiply-accumulate unit from the multiply-accumulate units, a first time at which the first multiply-accumulate unit acquires data is earlier than a second time at which the second multiply-accumulate unit acquires data.

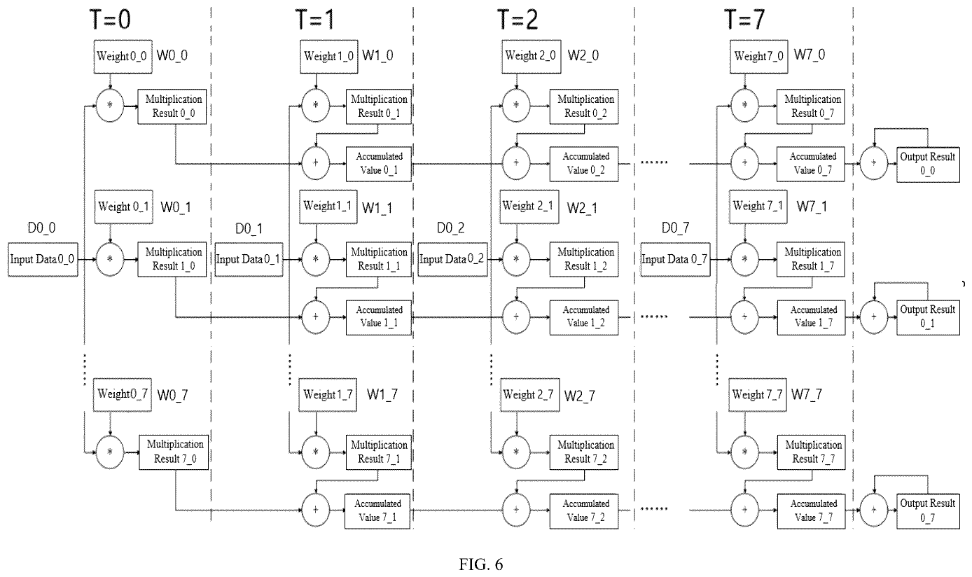

In an embodiment, as shown in FIG. 6, since the processing element includes an adder configured to perform accumulation operations, it is necessary that the computation of the previous processing element be completed before the computation of the next processing element is performed.

Specifically, at time T=0, the first column of the data matrix and the first row of the weight matrix are put into the matrix multiplication computation module 106, and multiplied to obtain the multiplication result. At time T=1, the second column of the data matrix and the second row of the weight matrix are put into the matrix multiplication computation module 106, and the multiplication result is obtained and added to the result computed at T=0. After all the data of the data matrix and the weight matrix are sequentially put into the matrix multiplication computation module 106, the multiplication computation of the 8×8 matrix is completed at time T=7 to obtain a final result. It can be seen that when a pipeline is full, the matrix multiplication computation module 106 with a computational scale of 8×8×8 can complete an 8×8 matrix multiplication computation once per clock cycle.

Exemplarily, on a condition that a quantity of data of the first matrix and/or the second matrix in any dimension is less than a number of the processing elements or an integer multiple of the number of the processing elements of the three-dimensional array in the dimension, the quantity of data in the first matrix and/or the second matrix in the dimension is padded with zeros to the number of the processing elements or the integer multiple of the number of the processing elements of the three-dimensional array in the dimension.

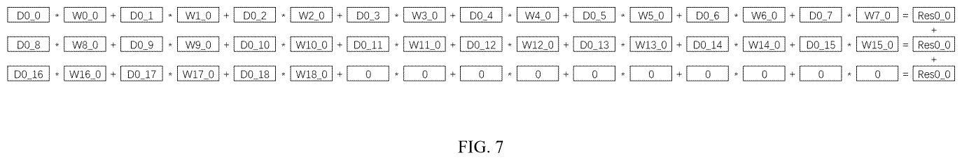

In an embodiment, on a condition that the first matrix and the second matrix are both 19×19 matrices and the matrix multiplication computation module has a computational scale of 8×8×8, and the matrix multiplication computation of the first matrix and the second matrix is as shown in equation (2):

$$[ \begin{matrix}{O}_{0 \_ 0} & {O}_{0 \_ 1} & {O}_{0 \_ 2} & … & {O}_{0 \_ 18} \\ {O}_{1 \_ 0} & {O}_{1 \_ 1} & {O}_{1 \_ 2} & ⋯ & {O}_{0 \_ 18} \\ {O}_{2 \_ 0} & {O}_{2 \_ 1} & {O}_{2 \_ 2} & … & {O}_{0 \_ 18} \\ ⋮ & ⋮ & ⋮ & ⋱ & ⋮ \\ {O}_{18 \_ 0} & {O}_{18 \_ 1} & {O}_{18 \_ 2} & … & {O}_{18 \_ 18}\end{matrix} ] = [ \begin{matrix}{D}_{0 \_ 0} & {D}_{0 \_ 1} & {D}_{0 \_ 2} & … & {D}_{0 \_ 18} \\ {D}_{1 \_ 0} & {D}_{1 \_ 1} & {D}_{1 \_ 2} & ⋯ & {D}_{1 \_ 18} \\ {D}_{2 \_ 0} & {D}_{2 \_ 1} & {D}_{2 \_ 2} & … & {D}_{2 \_ 18} \\ ⋮ & ⋮ & ⋮ & ⋱ & ⋮ \\ {D}_{18 \_ 0} & {D}_{18 \_ 1} & {D}_{18 \_ 2} & … & {D}_{18 \_ 18}\end{matrix} ] \times [ \begin{matrix}{W}_{0 \_ 0} & {W}_{0 \_ 1} & {W}_{0 \_ 2} & … & {W}_{0 \_ 18} \\ {W}_{1 \_ 0} & {W}_{1 \_ 1} & {W}_{1 \_ 2} & ⋯ & {W}_{1 \_ 18} \\ {W}_{2 \_ 0} & {W}_{2 \_ 1} & {W}_{2 \_ 2} & … & {W}_{2 \_ 18} \\ ⋮ & ⋮ & ⋮ & ⋱ & ⋮ \\ {W}_{18 \_ 0} & {W}_{18 \_ 1} & {W}_{18 \_ 2} & … & {W}_{18 \_ 18}\end{matrix} ] , \qquad ( 2 )$$

where the computational process of multiplying the first row and the first column is shown in FIG. 7. It is necessary to pad 19 multiplication and addition operations to 8-byte alignment, and then accumulate the results of 3 clock cycles to get the final result. Therefore, 8×19 and 19×8 matrix multiplications can be done in 3 clock cycles. The 19×19 matrix multiplication computation will be split into nine 8×19 and 19×8 matrix multiplications for computation, so 27 clock cycles are required to complete the 19×19 matrix multiplication computation.

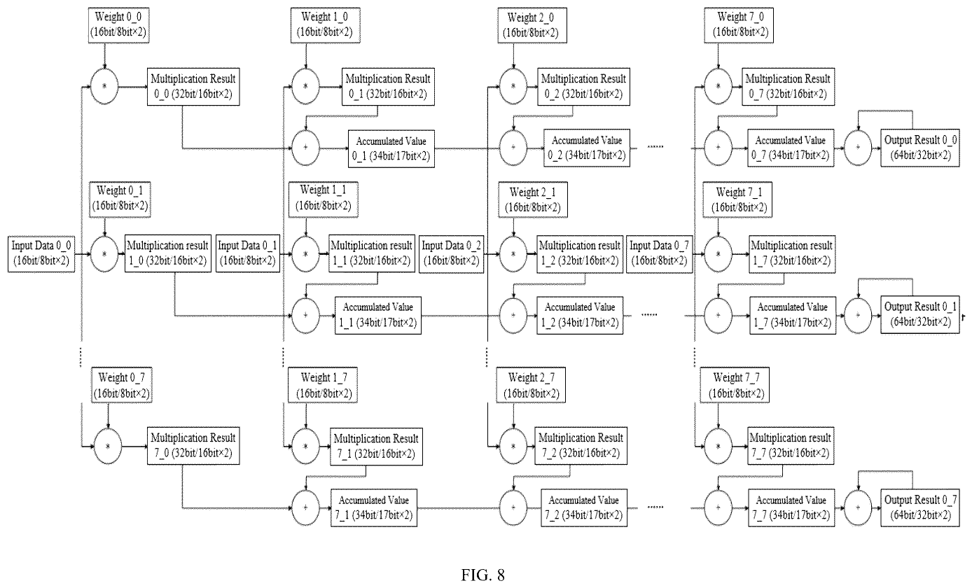

In an embodiment, according to the principle of booth multiplier, a 16-bit multiplier can complete two 8-bit multiplication operations, so a three-dimensional array for 8×8×8 int16 matrix multiplications can also be regarded as two three-dimensional arrays for 8×8×8 int8 matrix multiplications, as shown in FIG. 8. In other words, the same computing unit can complete two 8×8 int8 matrix multiplications per clock cycle. Similarly, without modifying the data cache and data reading module, only modifying the matrix multiplication computation module can support one 8×8 FP16/BF16 and 4×8 FP32 matrix multiplication per clock cycle.

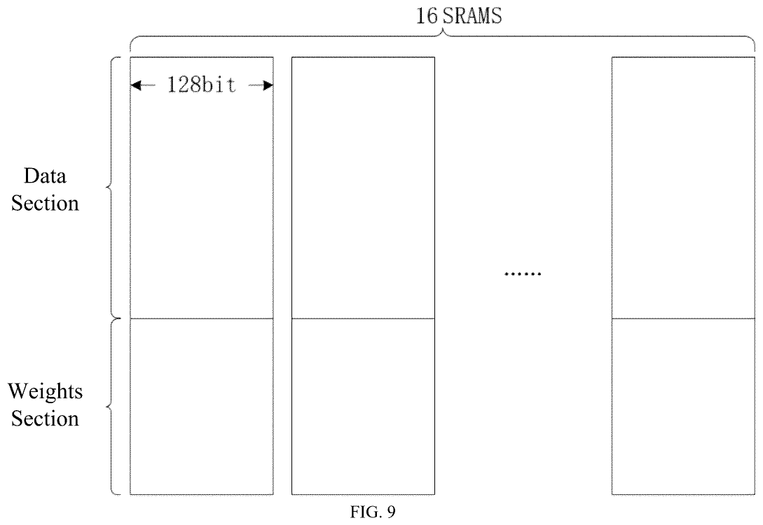

In some embodiments, as shown in FIG. 1, before using the above-mentioned matrix multiplication computation module 106 to perform matrix multiplication computation, a step of reading data needs to be performed. The process of reading data from external storage and then sending it to the matrix multiplication computation module 106 for computation is completed by the data reading module 102 and the data acquisition module 104. The data reading module 102 acquires data from the external storage and puts the acquired data into the data cache 103. The data acquisition module 104 reads data from the data cache 103 in the sequence of computation. For the computational scale of 8×8×8 int16, the data cache 103 includes 16 static random access memories (SRAMs), and the bit width of each SRAM is 128 bit, as shown in FIG. 9. The proportion of the data matrix and the weight matrix occupying the cache can be flexibly configured by registers according to specific needs.

In an embodiment, during a single computation, an entire weight matrix will be loaded into the data cache 103, and the data matrix will read a minimum number of rows according to the computational scale. For example, for a computational scale of 8×8×8, 8 rows of data matrix are read each time, and the next 8 rows of data are computed after the previous 8 rows of data are computed. Therefore, the data of the two matrices will only be read once in a single computation.

In an embodiment, the data acquisition module 104 can obtain 2048 bit (128×16) of data or weights from the data cache 103 per clock cycle, and the data and weights are read alternately. Two groups of 8×8 int16 data and weights can be obtained every per clock cycles, which are enough for the matrix multiplication computation module to complete the computation of 2 clock cycles.

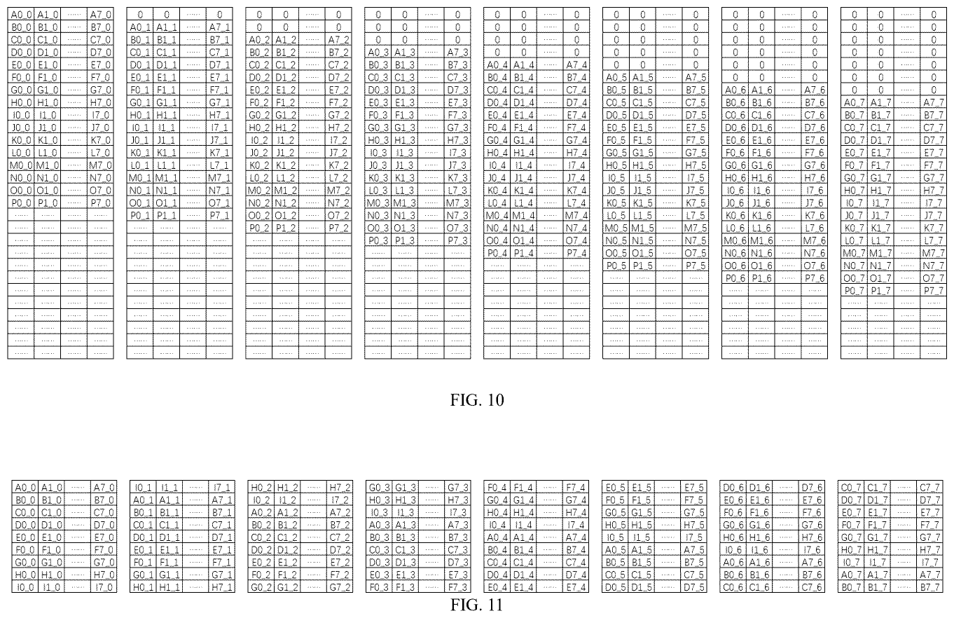

In an embodiment, after the data acquisition module 104 obtains required data from the data cache 103, the data are further arranged in the data queue 105 according to the computational sequence. In order to satisfy the sequence requirement of inputting the data to the matrix multiplication computation module 106, multiple SRAMs are required to store data separately, and the data are stored in staggered rows and subsequently retrieved by rows. For the computational scale of 8×8×8 int16, the data queue includes 8 SRAMs, where A, B, C, . . . represent multiple 8×8 data matrices, as shown in FIG. 10. Referring to the computational process in FIG. 6, at time T=0, the first rows of data of all SRAMs are taken out and sent to the matrix multiplication computation module 106, at time T=1, the second rows of data are taken out and sent to the matrix multiplication computation module 106, and for the other rows, the same process is applied sequentially. The bit width of each SRAM is 128 bits. To prevent access conflicts during cyclic read and write, the SRAM is configured with a depth of 9 rows, as shown in FIG. 11. The weight matrix is also configured in the same way.

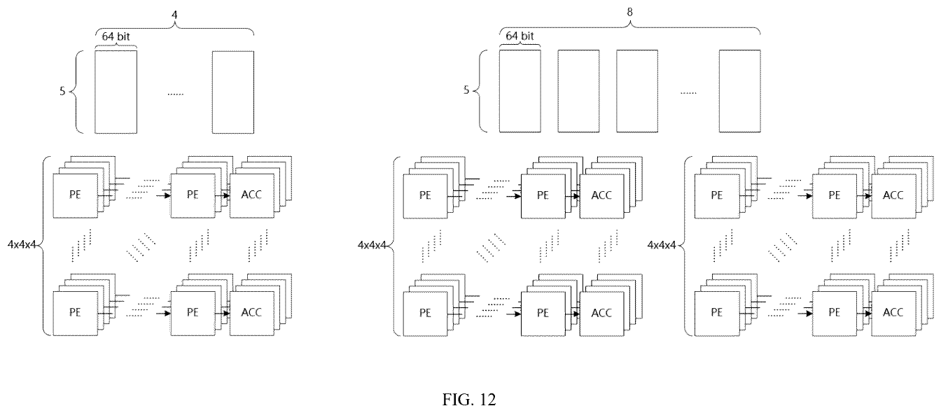

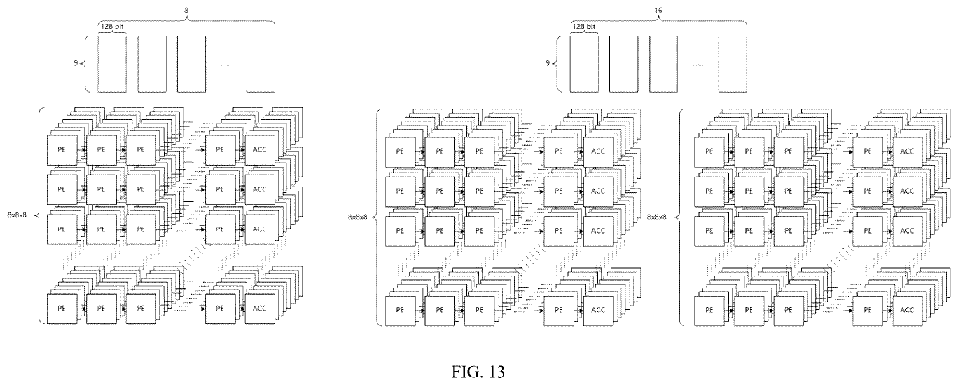

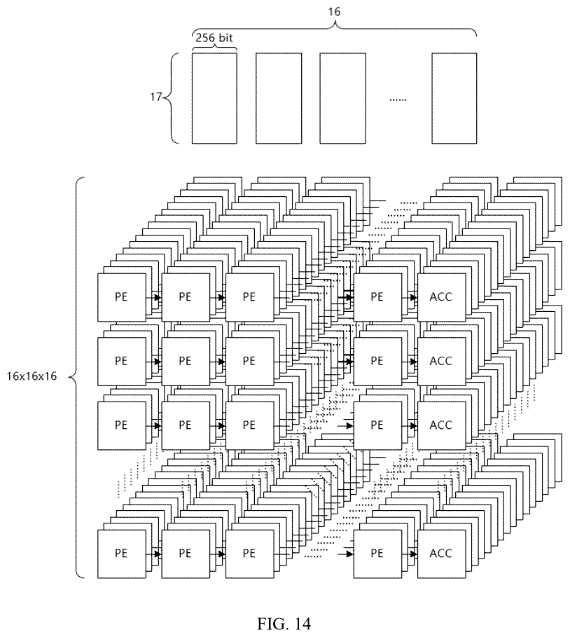

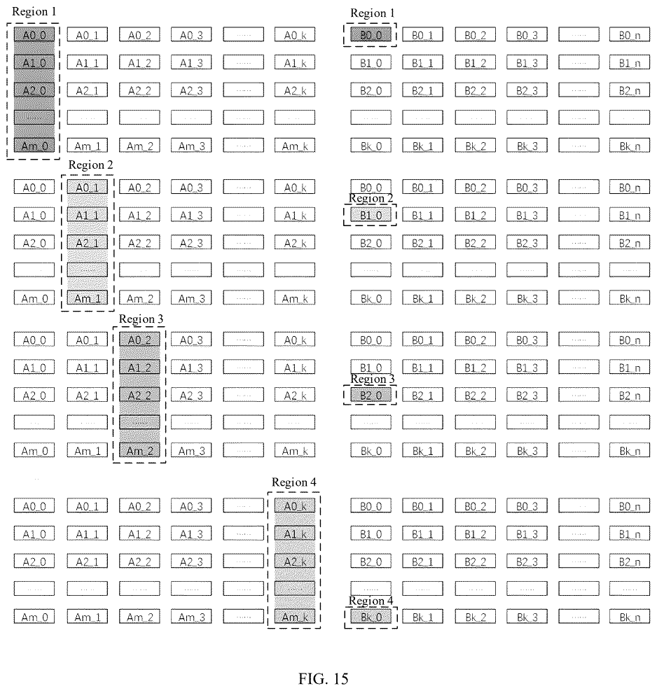

In an embodiment, a computational scale of the three-dimensional array is proportional to a computational power of the matrix multiplication computation module 106. Therefore, the computing scale of the matrix multiplication computation module that matches the computational power requirements can be selected according to the computational power requirements of the application scenario. The computing scales of the matrix multiplication computation module include but is not limited to a 4×4×4 three-dimensional array (as shown in FIG. 12), an 8×8×8 three-dimensional array (as shown in FIG. 13), a 16×16×16 three-dimensional array (as shown in FIG. 14), etc. At different clock frequencies, different computing scales provide corresponding computational power as shown in Table 1. The appropriate computing scale can be selected according to a designed clock frequency and target computational power requirements.

Table 1 shows a relationship between computational power and computing scale:

| Clock | | | | | |
|---|---|---|---|---|---|
| Frequency | Computing | Number | TOPS | TOPS | TOPS |
| (MHz) | Scale | of Units | (int16) | (int8) | (int4) |
| 450 | 4 × 4 × 4 | 1 | 0.0288 | 0.0576 | 0.1152 |
| | 4 × 4 × 4 | 2 | 0.0576 | 0.1152 | 0.2304 |
| | 8 × 8 × 8 | 1 | 0.2304 | 0.4608 | 0.9216 |
| | 8 × 8 × 8 | 2 | 0.4608 | 0.9216 | 1.8432 |
| | 16 × 16 × 16 | 1 | 1.8432 | 3.6864 | 7.3728 |
| 600 | 4 × 4 × 4 | 1 | 0.0384 | 0.0768 | 0.1536 |
| | 4 × 4 × 4 | 2 | 0.0768 | 0.1536 | 0.3072 |
| | 8 × 8 × 8 | 1 | 0.3072 | 0.6144 | 1.2288 |
| | 8 × 8 × 8 | 2 | 0.6144 | 1.2288 | 2.4576 |
| | 16 × 16 × 16 | 1 | 2.4576 | 4.9152 | 9.8304 |
| 1000 | 4 × 4 × 4 | 1 | 0.064 | 0.128 | 0.256 |
| | 4 × 4 × 4 | 2 | 0.128 | 0.256 | 0.512 |
| | 8 × 8 × 8 | 1 | 0.512 | 1.024 | 2.048 |
| | 8 × 8 × 8 | 2 | 1.024 | 2.048 | 4.096 |
| | 16 × 16 × 16 | 1 | 4.096 | 8.192 | 16.384 |

In an embodiment, when the first matrix is M rows and K columns (M×K), the second matrix is K rows and N columns (K×N), and the matrix multiplication computation module has a 16×16×16 computing scale, an appropriate small matrix size is first selected based on the memory access bandwidth and cache size of the accelerator. A complete matrix is then split into multiple small matrices. Assuming that the size of a small matrix is 256×256, after splitting, it is as shown in equation (3):

$$[ \begin{matrix}{C}_{0 , 0} & {C}_{0 , 1} & {C}_{0 , 2} & … & {C}_{0 , n} \\ {C}_{1 , 0} & {C}_{1 , 1} & {C}_{1 , 2} & ⋯ & {C}_{1 , n} \\ {C}_{2 , 0} & {C}_{2 , 1} & {C}_{2 , 2} & … & {C}_{2 , n} \\ ⋮ & ⋮ & ⋮ & ⋱ & ⋮ \\ {C}_{m , 0} & {C}_{m , 1} & {C}_{m , 2} & … & {C}_{m , n}\end{matrix} ] = [ \begin{matrix}{A}_{0 , 0} & {A}_{0 , 1} & {A}_{1 , 2} & … & {A}_{0 , k} \\ {A}_{1 , 0} & {A}_{1 , 1} & {A}_{1 , 2} & ⋯ & {A}_{1 , k} \\ {A}_{2 , 0} & {A}_{2 , 1} & {A}_{2 , 2} & … & {A}_{2 , k} \\ ⋮ & ⋮ & ⋮ & ⋱ & ⋮ \\ {A}_{m , 0} & {A}_{m , 1} & {A}_{m , 2} & … & {A}_{m , k}\end{matrix} ] \times [ \begin{matrix}{B}_{0 , 0} & {B}_{0 , 1} & {B}_{0 , 2} & … & {B}_{0 , n} \\ {B}_{1 , 0} & {B}_{1 , 1} & {B}_{1 , 2} & ⋯ & {B}_{1 , n} \\ {B}_{2 , 0} & {B}_{2 , 1} & {B}_{2 , 2} & … & {B}_{2 , n} \\ ⋮ & ⋮ & ⋮ & ⋱ & ⋮ \\ {B}_{k , 0} & {B}_{k , 1} & {B}_{k , 2} & … & {B}_{k , n}\end{matrix} ] \qquad ( 3 )$$

where n=N/256-1, m=M/256-1, k=K/256-1, and the matrix size of each A, B, and Cis 256×256. The misaligned ones are aligned by zero padding.

In order to reduce the number of memory accesses, the data of matrix B will be read only once. Therefore, the matrix multiplication computation module 106 processes all operations of each small matrix B before switching to the next small matrix B for matrix multiplication computation. The computation results of each small matrix B are accumulated by the matrix accumulation module 107. The operation sequence is as follows:

$${C}_{0 , 0} = {A}_{0 , 0} * {B}_{0 , 0}$$

$${C}_{1 , 0} = {A}_{1 , 0} * {B}_{0 , 0}$$

$$…$$

$${C}_{m , 0} = {A}_{m , 0} * {B}_{0 , 0}$$

$${C}_{0 , 0} += {A}_{0 , 1} * {B}_{1 , 0}$$

$${C}_{1 , 0} += {A}_{1 , 1} * {B}_{1 , 0}$$

$$…$$

$${C}_{m , 0} += {A}_{m , k} * {B}_{k , 0}$$

When deploying the above operation process to the accelerator, C_{0,0}, C_{1,0}, . . . , C_{m,0} and A_{0,0}, A_{1,0}, . . . , A_{m,0} can be combined together, so the single computation of the accelerator is a matrix multiplication of M×256 and 256×256, as shown in the region 1 in FIG. 15. After the computation is completed, the process switches to the next matrix B and the next column of matrices A, to continue the computation, and the computation result is accumulated with the result of previous computation, as shown in the region 2 in FIG. 15. When the computation of B_{k,0} is completed, the result of the first column of matrices C is obtained, and then the process switches to the next column of matrix B. Then the entire M×K and K×N matrix multiplication operations are completed in sequence, as shown in the region 3 and region 4 in FIG. 15.

According to the hardware accelerator for matrix multiplication operations provided in the present disclosure, the data acquisition module is configured to acquire two matrices by performing matrix multiplication operations to form data queues. Each of the processing elements in the matrix multiplication computation module that forms the three-dimensional array acquires corresponding data in the two matrices to perform matrix multiplication operations, thereby improving the hardware computational power of the matrix multiplication operations.

Please note that the above embodiments are for illustrative purposes only and do not limit the present disclosure.

The various embodiments in this specification are described in a progressive manner, and each embodiment focuses on the differences from other embodiments. The same and similar parts between the embodiments can be referred to each other.

The technical features of the above embodiments can be combined arbitrarily. In order to make the description concise, all possible combinations of the technical features in the above embodiments are not described. However, as long as there is no contradiction in the combination of these technical features, they should be considered as the scope of this specification.

The above embodiments only express several implementation methods of the present disclosure, and the description is relatively specific and detailed, but it cannot be understood as a limitation on the scope of the patent disclosure. It should be pointed out that for ordinary technicians in this field, several modifications and improvements can be made without departing from the concept of the present disclosure, which all belong to the protection scope of the present disclosure. Therefore, the protection scope of the present disclosure shall be subject to the appended claims.

What is claimed is:

1. A hardware accelerator for matrix multiplication operations, comprising:
a data acquisition module configured to acquire a first matrix and a second matrix, the first matrix forming a first data queue in a first dimension and a second dimension, and the second matrix forming a second data queue in the first dimension and a third dimension; and
a matrix multiplication computation module comprising a three-dimensional array, the three-dimensional array comprising a plurality of processing elements, positions of the processing elements in the three-dimensional array being determined based on first dimension values, second dimension values and third dimension values of the processing elements, respectively, the processing elements being configured to obtain corresponding first data from the first data queue based on the first dimension values and the second dimension values, obtain corresponding second data from the second data queue based on the first dimension values and the third dimension values, and perform matrix multiplication computation based on the first data and the second data.

2. The hardware accelerator according to claim 1, wherein each of the plurality of the processing elements comprises a multiply-accumulate unit, the multiply-accumulate unit comprises a multiplier and an adder, the multiplier is configured to obtain products of the first data in the first matrix and the second data in the second matrix, and the adder is configured to accumulate the products along the first dimension.

3. The hardware accelerator according to claim 2, wherein the matrix multiplication computation module further comprises a plurality of adding units, each of the plurality of adding units comprises an adder, the adding units are arranged in a one-to-one correspondence with the processing elements at an end of the first dimension of the three-dimensional array, and the adding units are configured to obtain an accumulated value of products from the processing elements at the end of the first dimension of the three-dimensional array.

4. The hardware accelerator according to claim 1, wherein on a condition that the processing element has a first dimension value of A, a second dimension value of B, and a third dimension value of C in the three-dimensional array, the first data with the first dimension value of A and the second dimension value of B in a data queue of the first matrix, and the second data which with the first dimension value of A and the third dimension value of C in a data queue of the second matrix are acquired by the processing element, and matrix multiplication computations are performed on the first data and the second data.

5. The hardware accelerator according to claim 2, wherein on a condition that the multiply-accumulate unit has a first dimension value of A, a second dimension value of B, and a third dimension value of C in the three-dimensional array, products of the first data and the second data are acquired, the first data having the first dimension value of A and the second dimension value of B in the first matrix, the second data having the first dimension value of A and the third dimension value of C in the second matrix, and an accumulated value of products from all the multiply-accumulate units with the first dimension value less than or equal to A, the second dimension value of B, and the third dimension value of C in the three-dimensional array is acquired.

6. The hardware accelerator according to claim 2, wherein on a condition that the first dimension value of a first multiply-accumulate unit is less than the first dimension value of a second multiply-accumulate unit from the multiply-accumulate units, a first time at which the first multiply-accumulate unit acquires data is earlier than a second time at which the second multiply-accumulate unit acquires data.

7. The hardware accelerator according to claim 6, wherein the first data queue and the second data queue are arranged in staggered rows.

8. The hardware accelerator according to claim 1, wherein on a condition that a quantity of data of the first matrix in any dimension is less than a number of the processing elements or an integer multiple of the number of the processing elements of the three-dimensional array in the dimension, the quantity of data in the first matrix in the dimension is padded with zeros to the number of the processing elements or the integer multiple of the number of the processing elements of the three-dimensional array in the dimension.

9. The hardware accelerator according to claim 1, wherein on a condition that a quantity of data of the second matrix in any dimension is less than a number of the processing elements or an integer multiple of the number of the processing elements of the three-dimensional array in the dimension, the quantity of data in the second matrix in the dimension is padded with zeros to the number of the processing elements or the integer multiple of the number of the processing elements of the three-dimensional array in the dimension.

10. The hardware accelerator according to claim 1, wherein on a condition that a quantity of data of the first matrix and the second matrix in any dimension is less than a number of the processing elements or an integer multiple of the number of the processing elements of the three-dimensional array in the dimension, the quantity of data in the first matrix and the second matrix in the dimension is padded with zeros to the number of the processing elements or the integer multiple of the number of the processing elements of the three-dimensional array in the dimension.

11. The hardware accelerator according to claim 1, wherein a computational scale of the three-dimensional array is proportional to a computational power of the matrix multiplication computation module.

12. The hardware accelerator according to claim 1, wherein the first matrix comprises a data matrix, and the second matrix comprises a weight matrix.

13. The hardware accelerator according to claim 1, wherein the hardware accelerator further comprises a storage interface, a data reading module, a data cache, and a matrix accumulation module.

14. The hardware accelerator according to claim 1, wherein a computing scale of the matrix multiplication computation module is a P×Q×R three-dimensional array, and P, Q, and R are integers equal to or greater than 4.

15. The hardware accelerator according to claim 14, wherein P, Q, and R are equal, and a value of P is 4, 8, or 16.
